(19) United States
(12) Patent Application Publication
(10) Pub. No.: US 2024/0043669 A1
(43) Pub. Date: Feb. 8, 2024

(54) POLYPROPYLENE COMPOSITIONS WITH IMPROVED CLARITY

(71) Applicant: FINA TECHNOLOGY, INC., Houston, TX (US)

(72) Inventors: Adrienne MUSIC, Pasadena, TX (US); Fengkui LI, Houston, TX (US)

(21) Appl. No.: 18/230,007

(22) Filed: Aug. 3, 2023

Related U.S. Application Data
(60) Provisional application No. 63/395,035, filed on Aug. 4, 2022.

(51) Int. Cl. C08L 23/10; C08K 5/1575; C08K 5/20; C08K 5/521; B29C 45/00; B29C 48/00

(52) U.S. Cl. CPC C08L 23/10; C08K 5/1575; C08K 5/20; C08K 5/521; B29C 45/0001; B29C 48/022; C08L 2201/10; C08L 2203/30; C08L 2314/02; C08L 2314/06; B29C 2945/76531; B29C 2948/92704; B29K 2023/10

(57) ABSTRACT

A polymeric composition is disclosed. The composition can include (a) at least 95 wt. % of a polypropylene, (b) a clarifying agent, and (c) a nucleating agent, wherein the presence of the clarifying agent and nucleating agent in the polymeric composition decreases the haze value, as determined by ASTM D1003 at a thickness of 40-80 mil, of the polymeric composition when compared with the haze value of the polymeric composition having the clarifying agent but not the nucleating agent.

### CROSS REFERENCE TO RELATED APPLICATIONS

The present application claims priority to U.S. Provisional Application 63/395,035 filed Aug. 4, 2022. The contents of the referenced application are incorporated into the present application by reference.

### BACKGROUND OF THE INVENTION

### A. Field of the Invention

The invention generally concerns polypropylene compositions that include additives. In some aspects, the polypropylene compositions can include a combination of a clarifying agent (e.g., a nonitol-based clarifying agent or a trisamide-based clarifying agent) and a nucleating agent (e.g., a phosphate ester based nucleating agent) that can improve the clarity and/or stiffness of the compositions.

### B. Description of Related Art

Polypropylene belongs to the family of polymers known as polyolefins, and is one of the most widely-used polymers today. Polypropylene is typically considered a commodity chemical, with large volumes produced for the automotive industry, consumer goods, and the furniture industry. As polypropylene technology has improved, polypropylene applications have extended into specialty fields, like medical devices and aircraft components.

Polypropylene is made from polymerization of monomers of propene (C₃H₆), and typically involves the use of one of two catalyst types, a Ziegler-Natta or a metallocene catalyst. Each propene monomer includes a polymerizable element consisting of two carbon atoms with a double bond between them, and a pendant methyl group attached to one of the two carbon atoms. Monomer polymerizable elements chemically react with each other to provide a long hydrocarbon chain with one pendant methyl group present for every two carbon atoms in the chain.

Each propene monomer can be oriented in one of two ways when it polymerizes. As a result, the pendant methyl group attached to each propene monomer becomes secured in one of two orientations. The collective pattern in which the pendant methyl groups become oriented along the polymer chain leads to different basic chain structures. Isotactic polypropylene (iPP) has a uniform and recurring methyl group arrangement in which the methyl groups are oriented on one side of the polymer chain. Syndiotactic polypropylene (sPP) has a uniform and alternating methyl group arrangement in which the methyl groups are oriented on alternating sides of the polymer chain. Atactic propylene (aPP) has an irregular pendant methyl group arrangement with no orientation pattern. The overall orientation pattern of the pendant methyl groups affects the degree to which polymer chains can become aligned with one another, a property known as crystallinity.

Polypropylene is a semi-crystalline polymer that includes ordered regions with aligned polymer chains and amorphous regions that lack clearly defined shape or form. The organized or crystalline areas are called spherulites and can vary in shape and size with amorphous areas existing between the crystalline areas. The degree of crystallinity can affect characteristics of the polymer such as stiffness, as well as the chemical and thermal resistance of the material.

As polypropylene cools from a melted state to a solid state, spherulite nucleation is initiated around microscopic sites naturally present in the material. The spherulites continue to grow around nucleation sites and ultimately grow to become larger than the wavelength of visible light. Large spherulites scatter light and result in a material that appears hazy. A hazy appearance can be undesirable for applications like packaging, where visual appeal is a high priority. Polypropylene's haziness can be a limiting factor for its inclusion in end products wherein transparence is desired. This haziness can be more prevalent when the polypropylene has been formed (e.g., by injection molding) into an article of manufacture having an increased thickness when compared with thin films.

### SUMMARY OF THE INVENTION

A discovery has been made that provides for a polypropylene composition having improved clarity and/or stiffness. In one aspect of the present invention, it was discovered that a polypropylene composition including a clarifying agent such as a nonitol-based or trisamide-based clarifying agent and a nucleating agent such as a phosphate ester based nucleating agent can improve the haze value of the polypropylene composition. As illustrated in a non-limiting manner in the Examples, such a combination of clarifying and nucleating agents surprisingly resulted in reduced haze value when compared with (1) a polypropylene composition with the nucleator and not the clarifier and (2) a polypropylene composition with the clarifier and not the nucleator. In particular, it was discovered that a polypropylene composition with a nucleator had a high haze value, a polypropylene composition with the clarifier had a lower haze value, and a polypropylene composition with the nucleator and the clarifier had the lowest haze value. It was unexpected that the presence of the nucleator with the clarifier improved the haze value when compared with the same composition that had the clarifier and not the nucleator. In some aspects, the clarifying agent can be 1,2,3-trideoxy-4,5:5,7-bis-O-[(4-propylphenyl)methylene]-nonitol) or 1,3,5-benzenetrisamide amide derivative (e.g., 1,3,5-tris(2,2-dimethyl propanamido)benzene) and the nucleating agent can be 2,2′-methylenebis (4,6,-di-tertbutylphenyl) phosphate. This improved clarity can be particularly advantageous in applications where the polypropylene polymer has been formed (e.g., by injection molding) into an article of manufacture that has a thickness of at least 2 mil, preferably at least 5 mil, more preferably at least 10 mil, or even more preferably 20 mil to 300 mil, or even more preferably 20 mil to 100 mil. For example, having increased thickness while improving the clarity of the polypropylene composition can allow for more applications for the polypropylene composition where clarity is desired. Still further, it was also discovered that a polypropylene composition including the clarifying agent and the nucleating agent can improve the tensile modulus of the polypropylene composition. As illustrated in a non-limiting manner in the Examples, such a combination of clarifying and nucleating agents surprisingly resulted in increased tensile modulus when compared with a polypropylene composition with the clarifier and not the nucleator. These attributes open up a wide range of applications and/or uses for the polypropylene compositions of the present invention.

In one aspect of the present invention, there is disclosed a polymeric composition comprising at least 95, 96, 97, 98, or 99 wt. % of a polypropylene, a clarifying agent, and a nucleating agent. In some aspects, the presence of the clarifying agent and nucleating agent in the polymeric composition decreases the haze value, as determined by ASTM D1003. In some aspects, the haze value is measured at a polypropylene molded plaque thickness of 20-80 mil, preferably 40-80 mil, or more preferably 60-80 mil, where 1 mil is a measurement that equals one-thousandth of an inch (0.001 inch). In some aspects, the haze value is measured at a polypropylene molded plaque thickness of 20, 40, 50, 60, 70, or 80 mils, or preferably 20, 40, 60, or 80 mils, or more preferably 40, 60, or 80 mils. In some aspects, the decreased haze value is in comparison to the haze value of the polymeric composition having the clarifying agent but not the nucleating agent or having the nucleating agent and not the clarifying agent. In some aspects, a polypropylene composition that includes a clarifying agent and a nucleating agent exhibits a haze value is decreased by at least 1%, preferably by at least 2%, more preferably by 1% to 5%, or even more preferably by 2% to 5%, in comparison to a haze value of a polymeric composition having the clarifying agent but not the nucleating agent or the nucleating agent and not the clarifying agent. In some aspects, the haze value of the polymeric composition comprising the clarifying agent and the nucleating agent is less than or equal to 20% or 15% to 20%, as determined by ASTM D1003. By comparison, the haze value of a polymeric composition comprising the clarifying agent but not the nucleating agent is greater than 20%, or greater than 20% to 25%.

In one aspect, the composition comprises from 0.01 to 0.5 wt. % of the clarifying agent or 0.01, 0.02, 0.03, 0.04, 0.05, 0.06, 0.07, 0,08, 0.09, 0.1, 0.2, 0.3, 0.4, or 0.5 wt. % or any range therein. The composition can also include from 0.01 to 0.5 wt. % of the nucleating agent or 0.01, 0.02, 0.03, 0.04, 0.05, 0.06, 0.07, 0,08, 0.09, 0.1, 0.2, 0.3, 0.4, or 0.5 wt. % or any range therein. In one aspect, the composition comprises 0.1 to 0.3 wt. % of the clarifying agent, and 0.05 to 0.2 wt. % of the nucleating agent. In other aspects, the composition comprises the clarifying agent and the nucleating agent at a wt. % ratio of 0.01/5 to 0.5/0.01.

In some aspects, the clarifying agent is a nonitol-based clarifying agent or a trisamide-based clarifying agent and the nucleating agent is a phosphate ester based nucleating agent. In some aspects, the clarifying agent is a nonitol-based clarifying agent or a trisamide-based clarifying agent. In particular aspects, the nonitol-based clarifying agent is 1,2,3-trideoxy-4,5:5,7-bis-O-[(4-propylphenyl)methylene]-nonitol, or the trisamide-based clarifying agent is a 1,3,5-benzenetrisamide amide derivative, preferably 1,3,5-tris(2,2-dimethyl propanamido)benzene. In some aspects, the clarifying agent is 1,2,3,4-dibenzylidene sorbitol, 1,2,3,4-di-para-methylbenzylidene sorbitol, or 1,2,3,4-di-meta, para-methylbenzylidene sorbitol.

In some aspects, the nucleating agent is a phosphate ester based nucleating agent. In some aspects, the phosphate ester based nucleating agent is 2,2′-methylenebis (4,6,-di-tertbutylphenyl) phosphate. In some aspects, the phosphate ester based nucleating agent further includes a dispersant.

In some aspects, the polypropylene is a homopolymer, a random copolymer, or a blend thereof. In some aspects, at least a portion of monomers in the polypropylene random copolymer are ethylene monomers and/or butylene monomers. In some aspects, the polypropylene is a Zieglar-Natta catalyzed polypropylene or a metallocene-catalyzed polypropylene. In some aspects, the polymeric composition has a melt flow index of 0.2 to 150 g/10 min as measured by ASTM D1238 (230° C./2.16 kg). In some particular aspects, the polypropylene composition includes at least 95 wt. % of a random copolymer metallocene-catalyzed polypropylene having any one, any combination of, or all of the following characteristics: (1) melt flow of 9 g/10 min, as determined by ASTM D-1238; (2) a tensile strength @ break of 4,800 (35) psi (MPa), as determined by D-882; (3) an elongation @ break of 700%, as determined by ASTM D-882; (4) a 1% secant modulus of 100,000 (689) psi (MPa), as determined by ASTM D-882; (5) a gloss @ 45° of 80, as determined by ASTM D-2457; (6) a melting point of 289 (143) ° F. (° C.), as determined by ASTM D-3417, with melting point determined with a DSC-2 Differential Scanning Calorimeter; and/or (7) a density of 0.9 g/cc, as determined by ASTM D-1505. Data for (2)-(5) based on a non-oriented film—2 mil (50 microns).

In some aspects, the polymeric composition further comprises an additive. In some aspects, the additive is an antioxidant, an acid neutralizer, an antistatic agent, an antiblock agent, an antifog agent, an anticorrosion agent, a ultraviolet absorber, a lubricant, a plasticizer, a mineral oil, a wax, a clay, talc, calcium carbonate, diatomaceous earth, carbon black, mica, glass fibers, a filler, a slip agent, a pigments, an ultraviolet stabilizer, a fire retardant, a mold release agent, a dye, a blowing agent, a fluorescent agent, a surfactant, or any combination thereof. In some aspects, the polymeric composition has at least one property selected from the group consisting of a tensile modulus of 200,000 to 230,000 psi, as measured by ASTM D638, a tensile strength at yield of 4,400 to 4,800 psi, as measured by ASTM D638, a flex modulus of 180,000 psi to 220,000 psi, as measured by ASTM D790, and a notched izod impact strength of 0.5 to 1.5 ft-lbs/in, as measured by ASTM D256.

Some aspects of the disclosure are directed to an article of manufacture comprising any of the polymeric compositions disclosed herein. In some aspects, a method for making an article of manufacture comprises obtaining a polypropylene composition as disclosed herein, and making the article of manufacture by injection molding, blow molding, compression molding, stretch molding, rotational molding, transfer molding, sheet extrusion thermoforming, shallow-draw thermoforming, deep-draw thermoforming, or profile extrusion. In some aspects, a method for producing a polypropylene composition comprises obtaining a composition comprising at least 95, 96, 97, 98, or 99 wt. % of polypropylene and extruding the composition in the presence of a clarifying agent and a nucleating agent to obtain the polypropylene composition of the present invention. In some aspects, the method comprises extruding at a melt temperature of from 200° C. to 260° C.

In some aspects of the present invention, the polypropylene compositions and/or articles of manufacture formed from or comprising the polypropylene compositions can have a thickness of at least 2 mil, 3, mil, 4 mil, 5 mil, 6 mil, 7 mil, 8 mil, 9 mil, 10 mil, 15 mil, 20 mil, 25 mil, 30 mil, 35 mil, 40 mil, 45 mil, 50 mil, 55 mil, 60 mil, 65 mil, 70 mil, 75 mil, 80 mil, 85 mil, 90 mil, 95 mil, 100 mil, 110 mil, 120 mil, 130 mil, 140 mil, 150 mil, 160 mil, 170 mil, 180 mil, 190 mil, 200 mil, 210 mil, 220 mil, 230 mil, 240 mil, 250 mil, 260 mil, 270 mil, 280 mil, 290 mil, 300 mil, 350 mil, 400 mil, or 500 mil, or greater or any range or number therein (e.g., a thickness of at least 5 mil, at least 10 mil, 20 mil to 300 mil, 20 mil to 100 mil, 40 mil to 100 mil, 40 mil to 80 mil, etc.). In some preferred aspects, the thickness of the polypropylene compositions or articles of manufacture of the present invention can be 20 mil to 100 mil.

Other aspects or embodiments of the invention are discussed throughout this application. Any aspect or embodiment discussed with respect to one aspect of the invention applies to other aspects or embodiments of the invention as well and vice versa. Each aspect or embodiment described herein is understood to be aspects or embodiments of the invention that are applicable to other aspects of the invention. It is contemplated that any aspect or embodiment discussed herein can be combined with other aspects or embodiments discussed herein and/or implemented with respect to any method or composition of the invention, and vice versa. Furthermore, compositions and systems of the invention can be used to achieve methods of the invention.

Also disclosed in the context of the present invention are aspects 1-23. Aspect 1 includes a polymeric composition comprising: (a) at least 95 wt. % of a polypropylene; (b) a clarifying agent; and (c) a nucleating agent, wherein the presence of the clarifying agent and nucleating agent in the polymeric composition decreases the haze value, as determined by ASTM D1003 at a thickness of 40-80 mil, of the polymeric composition when compared with the haze value of the polymeric composition having the clarifying agent but not the nucleating agent. Aspect 2 is the polymeric composition of aspect 1, wherein the composition comprises 0.01 to 0.5 wt. % of the clarifying agent, and 0.01 to 0.5 wt. % of the nucleating agent. Aspect 3 is the polymeric composition of aspect 2, wherein the composition comprises 0.1 to 0.3 wt. % of the clarifying agent, and 0.05 to 0.2 wt. % of the nucleating agent, or wherein the composition comprises the clarifying agent and the nucleating agent at a wt. % ratio of 0.01/5 to 0.5/0.01. Aspect 4 is the polymeric composition of any one of aspects 1 to 3, wherein the clarifying agent is a nonitol-based clarifying agent or a trisamide-based clarifying agent and the nucleating agent is a phosphate ester based nucleating agent. Aspect 5 is the polymeric composition of aspect 4, wherein the nonitol-based clarifying agent is 1,2,3-trideoxy-4,5:5,7-bis-O-[(4-propylphenyl)methylene]-nonitol, or the trisamide-based clarifying agent is a 1,3,5-benzenetrisamide amide derivative, preferably 1,3,5-tris(2,2-dimethyl propanamido)benzene. Aspect 6 is the polymeric composition of any one of aspects 4 to 5, wherein the phosphate ester-based nucleating agent is 2,2′-methylenebis (4,6,-di-tertbutylphenyl) phosphate. Aspect 7 is the polymeric composition of aspect 4, wherein the clarifying agent is 1,2,3-trideoxy-4,5:5,7-bis-O-[(4-propylphenyl)methylene]-nonitol, and the nucleating agent is 2,2′-methylenebis (4,6,-di-tertbutylphenyl) phosphate. Aspect 8 is the polymeric composition of any one of aspects 1 to 7, wherein the presence of the clarifying agent and nucleating agent in the polymeric composition increases the tensile modulus, as determined by ASTM D638, of the polymeric composition when compared with the tensile modulus of the polymeric composition having the clarifying agent but not the nucleating agent. Aspect 9 is the polymeric composition of any one of aspects 1 to 8, wherein the haze value is decreased by at least 1%, preferably by at least 2%, more preferably by 1% to 5%, or even more preferably by 2% to 5%. Aspect 10 is the polymeric composition of any one of aspects 1 to 9, wherein the haze value of the polymeric composition comprising the clarifying agent and the nucleating agent is less than or equal to 20% or 15% to 20%, and wherein the haze value of the polymeric composition comprising the clarifying agent but not the nucleating agent is greater than 20% or greater than 20% to 25%. Aspect 11 is the polymeric composition of any one of aspects 1 to 10, wherein the polypropylene is a homopolymer or a random copolymer or a blend thereof. Aspect 12 is the polymeric composition of any one of aspects 1 to 11, wherein the polypropylene is a Zieglar-Natta catalyzed polypropylene or a metallocene-catalyzed polypropylene. Aspect 13 is the polymeric composition of any one of aspects 1 to 12, wherein the polymeric composition has a melt flow index of 0.2 to 150 g/10 min as measured by ASTM D1238 (230° C./2.16 kg). Aspect 14 is the polymeric composition of any one of aspects 1 to 13, wherein the polymeric composition further comprises an additive. Aspect 15 is the polymeric composition of aspect 14, wherein the additive is an antioxidant, an acid neutralizer, an antistatic agent, an antiblock agent, an antifog agent, an anticorrosion agent, a ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer, a fire retardant, a mold release agent, a dye, a blowing agent, a fluorescent agent, a surfactant, or any combination thereof. Aspect 16 is the polymeric composition of any one of aspects 1 to 15, wherein the polymeric composition has at least one of the following properties: a tensile modulus of 200,000 to 230,000 psi, as measured by ASTM D638; a tensile strength at yield of 4,400 to 4,800 psi, as measured by ASTM D638; a flex modulus of 180,000 psi to 220,000 psi, as measured by ASTM D790; and/or a notched izod impact strength of 0.5 to 1.5 ft-lbs/in, as measured by ASTM D256. Aspect 17 is the polymeric composition of any one of aspects 1 to 16, wherein the polymeric composition has a thickness of at least 2 mil, preferably at least 5 mil, more preferably at least 10 mil, or even more preferably 20 mil to 300 mil, or even still more preferably 20 mil to 100 mil. Aspect 18 is the polymeric composition of any one of aspects 1 to 17, wherein the polymeric composition is an injection molded polymeric composition.

Aspect 19 is an article of manufacture comprising the polymeric composition of any one of aspects 1 to 18.

Aspect 20 is a method of making the article of manufacture of aspect 19, the method comprising obtaining the polymeric composition of any one of aspects 1 to 18 and making the article of manufacture by injection molding, blow molding, compression molding, stretch molding, rotational molding, transfer molding, sheet extrusion thermoforming, shallow-draw thermoforming, deep-draw thermoforming, or profile extrusion. Aspect 21 is the article of manufacture of aspect 20, wherein the article of manufacture is an injection molded article of manufacture, preferably having a thickness of 20 mil to 100 mil.

Aspect 22 is a method of producing the polypropylene composition of any one of aspects 1 to 18, the method comprising: (a) obtaining a composition comprising: at least 95 wt. % of the polypropylene; a clarifying agent; and a nucleating agent; and (b) extruding the composition to obtain the polypropylene composition of any one of aspects 1-17. Aspect 23 is the method of aspect 22, wherein the extrusion conditions include melt temperatures of 200-260° C.

The following includes definitions of various terms and phrases used throughout this specification.

A polypropylene random copolymer is a copolymer produced by polymerization of propylene with greater than 0% and up to 10% total by weight of ethylene and/or butylene.

The terms “about” or “approximately” are defined as being close to as understood by one of ordinary skill in the art. In one non-limiting embodiment, the terms are defined to be within 10%, alternatively within 5%, alternatively within 1%, and alternatively within 0.5%.

The terms “wt. %,” “vol. %,” or “mol. %” refer to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component. The terms “ppm” refer to parts per million by weight of a component, based on the total weight, that includes the component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification include any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, X, Y, and/or Z can include: X alone, Y alone, Z alone, a combination of X and Y, a combination of X and Z, a combination of Y and Z, or a combination of X, Y, and Z.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process and systems of the present invention can “comprise,” “consist essentially of,” or “consist of” particular ingredients, components, compositions, steps, etc., disclosed throughout the specification. With respect to the transitional phrase “consisting essentially of,” in one non-limiting aspect, a basic and novel characteristic of the compositions and processes of the present invention includes a polypropylene composition that includes a clarifying agent and a nucleating agent and exhibits decreased haze.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a graph depicting tensile modulus of polypropylene compositions containing one or more additives.

FIG. 2 is a graph depicting tensile strength at yield of polypropylene compositions containing one or more additives.

FIG. 3 is a graph depicting flex modulus of polypropylene compositions containing one or more additives.

FIG. 4 is a graph depicting haze as a function of thickness of polypropylene molded plaques containing one or more additives.

### DETAILED DESCRIPTION OF THE INVENTION

One aspect of the present invention is based on a discovery that a polypropylene composition that includes both a clarifying agent and a nucleating agent exhibits decreased haze when compared with the same composition without the nucleating agent and/or when compared to the same composition without the clarifying agent. This improved clarity can be particularly advantageous in applications where the polypropylene polymer has been formed (e.g., by injection molding) into an article of manufacture that has a thickness, for example, greater than 2 mil, preferably at least 5 mil, more preferably at least 10 mil, or even more preferably 20 mil to 300 mil, or even still more preferably 20 mil to 100 mil. Also, and as illustrated in the examples, the polypropylene compositions of the present invention can have increased mechanical properties when compared with formulations containing the clarifying agent but not the nucleating agent. Examples of increased mechanical properties include tensile modulus, tensile strength, flex modulus, and/or notched izod impact strength values. These attributes open up a wide range of applications and/or uses for the polypropylene compositions of the present invention.

These and other non-limiting aspects of the present invention are discussed in further detail in the following sections.

### A. Polypropylene

The polymers of the present invention can include homopolymers (e.g., isotactic, syndiotactic, atactic polypropylene) of polypropylene, random copolymers of propylene, and blends thereof. In some aspects, a controlled rheology grade polypropylene (CRPP) can be used. A CRPP is one that has been further processed (e.g., through a degradation process) to produce a polypropylene polymer with a targeted high melt flow index (MFI), lower molecular weight, and/or a narrower molecular weight distribution than the starting polypropylene.

Polypropylene can be prepared by any of the polymerization processes, which are in commercial use (e.g., a “high pressure” process, a slurry process, a solution process and/or a gas phase process) and with the use of any of the known catalysts (e.g., Ziegler Natta catalysts, chromium or Phillips catalysts, single site catalysts, metallocene catalysts, and the like). Polypropylene can be prepared using methods described in U.S. Pat. Nos. 8,957,159, 8,088,867, 8,071,687, 7,056,991 and 6,653,254. The polypropylene can also be purchased through a commercial source such as those from TotalEnergies (USA), Total SA, Lyondell Bassel Industries, Reliance Industries Ltd, Sinopec, and ExxonMobil Chemical Co. The polypropylene can be in previously extruded and/or be in solid form, for example, pellets.

The polypropylene compositions of the present invention can contain at least 90 wt. % polypropylene, such as 90 wt. % to 100 wt. %, or equal to any one of, at least any one of, at most any one of, or between any two of 90, 91, 92, 93, 94, 95, 96, 97, 98, 99, 99.1, 99.2, 99.3, 99.4, 99.5, 99.6, 99.7, 99.8 and 99.9, 99.95 and 100 wt. % of the polypropylene based on the total weight of the polypropylene. In some aspects, the polypropylene can be a polypropylene homopolymer or a random copolymer polypropylene. In certain aspects, the polypropylene can have, any one of, any combination of, or all of the following characteristics: (1) melt flow of 0.5 g/10 min to 150 g/10 min, or equal to any one of, at least any one of, at most any one of, or between any two of 0.5, 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, and 150 g/10 min, measured in accordance with ASTM D1238 (230° C./2.16 kg), with a preferred melt flow being 5 to 15 g/10 min, (2) a tensile strength @ break of 2000 to 7000, preferably about 4,500 to 5,500 psi (MPa), as determined by D-882; (3) an elongation @ break of 300% to 1000%, preferably 600% to 800%, as determined by ASTM D-882; (4) a 1% secant modulus of 50,000 to 150,000, or preferably 75,000 to 125,000 psi, as determined by ASTM D-882; (5) a gloss @ 45° of 50 to 100, preferably 70 to 90, as determined by ASTM D-2457; (6) a melting point of 100° C. to 300° C., preferably 125° C. to 190° C., or even more preferably 140° C. to 180° C., or equal to any one of, at least any one of, at most any one of, or between any two of 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, and 180° C., as determined by ASTM D-3417, with melting point determined with a DSC-2 Differential Scanning Calorimeter; and/or (7) a density of 0.1 to 2 g/cc, preferably 0.7 to 1.1, g/cc, or even more preferably 0.85 g/cc to 0.95 g/cc, or equal to any one of, at least any one of, at most any one of, or between any two of 0.85, 0.86, 0.87, 0.88, 0.89, 0.9, 0.91, 0.92, 0.93, 0.94, and 0.95 g/cc, as determined by ASTM D-1505. Data for (2)-(5) based on a non-oriented film—2 mil (50 microns). In some aspects, the polypropylene is commercially available (e.g., Lumicene® M6571 from TotalEnergies (Houston, Texas) can be used in the context of the present invention.

### B. Clarifying Agents

Polypropylene compositions of the present invention can include a clarifying agent or a combination of clarifying agents. The clarifying agent can include a trisamide-based clarifier, a nonitol-based clarifier, and/or a sorbitol-based clarifier, or any combination thereof. Trisamide clarifiers include, but are not limited to, amide derivatives of benzene-1,3,5-tricarboxylic acid, amide derivatives of 1,3,5-benzenetriamine, derivatives of N-(3,5-bis-formylamino-phenyl)-formamide, derivatives of 2-carbamoyl-malonamide, and combinations thereof. In certain aspects the trisamide clarifier is N,N′,N″-benzene-1,3,5-triyltris(2,2-dimethylpropanamide). Nonitol-based clarifies include, but are not limited to, derivatives of nonitol, an example of which includes 1,2,3-trideoxy-4,5:5,7-bis-O-[(4-propylphenyl)methylene]-Nonitol (NX8000, CAS Reg. No. 882073-43-0, Milliken Chemical, Spartanburg, S.C.). Sorbitol clarifiers include, but are not limited to 1,2,3,4-dibenzylidene sorbitol (Millad 3905, CAS #: 32647-67-9, Milliken Chemical, Spartanburg, S. C.), 1,2,3,4-di-para-methylbenzylidene sorbitol (Millad 3940 CAS #: 54686-97-4, Milliken Chemical, Spartanburg, S.C.), and 1,2,3,4-di-meta, para-methylbenzylidene sorbitol (Millad 3998, CAS #: 135861-56-2, Milliken Chemical, Spartanburg, S.C.). Another clarifier that can be used in the context of the present invention includes NA-71 (ADK STAB NA-71) (Adeka Corporation, Tokyo, Japan). In some preferred aspects, the clarifier is 1,2,3-trideoxy-4,5:5,7-bis-O-[(4-propylphenyl)methylene]-Nontiol (NX8000, CAS Reg. No. 882073-43-0, Milliken Chemical, Spartanburg, S.C.). In other preferred aspects, the clarifier is a 1,3,5-benzenetrisamide amide derivative, preferably 1,3,5-tris(2,2-dimethyl propanamido)benzene (Irgacelar XT 386, BASF, Ludwigshafen, Germany).

The amount of clarifying agents that can be included in the polypropylene compositions of the present invention include 0.01 wt. % to 5 wt. % or any amount or range therein (e.g., 0.01 wt. %, 0.05 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 3.5 wt. %, 4 wt. %, 4.5 wt. %, 5 wt. %). In some preferred aspects, the polypropylene compositions of the present invention can include 0.01 wt. % to 0.5 wt. % of the clarifying agent(s) or any amount or range therein (e.g., 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, or 0.5 wt. %).

### C. Nucleating Agents

Polypropylene compositions of the present invention can include a nucleating agent or a combination of nucleating agents. The nucleating agent can include a phosphate ester based nucleating agent. Non-limiting examples of phosphate ester based nucleating agents include 2,2′-methylenebis (4,6,-di-tertbutylphenyl) phosphate or Hyperform HPN 715 (Milliken Chemical, Spartanburg, S.C.). 2,2′-methylenebis (4,6,-di-tertbutylphenyl) phosphate is commercially available from Adeka (Tokyo, Japan) under the tradenames ADK STAB NA-11 or ADK STAB NA-27. NA-27 is NA-11 in combination with a dispersant.

The amount of nucleating agents that can be included in the polypropylene compositions of the present invention include 0.01 wt. % to 5 wt. % or any amount or range therein (e.g., 0.01 wt. %, 0.05 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 3.5 wt. %, 4 wt. %, 4.5 wt. %, 5 wt. %). In some preferred aspects, the polypropylene compositions of the present invention can include 0.01 wt. % to 0.5 wt. % of the nucleating agent or any amount or range therein (e.g., 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, or 0.5 wt. %).

In certain aspects, the polypropylene compositions of the present invention can include the clarifying agent and the nucleating agent at a wt. % ratio of 0.01/5 to 0.5/0.01 or any ratio therein (e.g., 0.0002:1, 0.001:1, 0.01:1, 0.02:1, 0.03:1, 0.04:1, 0.05:1, 0.06:1, 0.07:1, 0.08:1, 0.09:1, 0.1:1, 0.2:1, 0.3:1, 0.4:1, 0.5:1, 0.6:1, 0.7:1, 0.8:1, 0.9:1, 1:1, 2:1, 3:1, 4:1, 5:1, 6:1, 7:1, 8:1, 9:1, 10:1, 15:1, 20:1, 25:1, 30:1, 35:1, 40:, 45:1, 50:1).

### D. Additives

The polypropylene compositions of the present invention can include various additives. Non-limiting examples of additives include an antiblocking agent, an antistatic agent, an antioxidant, a neutralizing agent, a blowing agent, a crystallization aid, a dye, a flame retardant, a filler, an impact modifier, a mold release agent, an oil, another polymer, a pigment, a processing agent, a reinforcing agent, a slip agent, a flow modifier, a stabilizer, an UV resistance agent, and combinations thereof. Additives are available from various commercial suppliers. Non-limiting examples of commercial additive suppliers include BASF (Germany), Dover Chemical Corporation (U.S.A.), AkzoNobel (The Netherlands), Sigma-Aldrich® (U.S.A.), Atofina Chemicals, Inc., and the like. The amount of optional additives can range from 0.01 wt. % to 5 wt. % (e.g., 0.01 wt. %, 0.05 w.t %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 3.5 wt. %, 4 wt. %, 4.5 wt. %, 5 wt. %, or any value or range there between) in the polypropylene composition.

### E. Method of Making the Polymeric Composition

Polymeric compositions of the present invention can be made by blending the polypropylene with the clarifying and nucleating agents and optionally with other additives together. In some aspects, the polypropylene can be in a solid form (e.g., pellets) and can be melted and mixed with the clarifying and nucleating agents and optional other additives. Suitable blending machines are known to those skilled in the art. Non-limiting examples include mixers, kneaders and extruders. In certain aspects, the process can be carried out with an extruder by introducing the polypropylene and clarifying and nucleating agents and other additives to the extruder hopper. Non-limiting examples of an extruder includes single-screw extruders, contrarotating and co-rotating twin-screw extruders, planetary-gear extruders, ring extruders, or co-kneaders. The melt blending can be performed at a melt temperature of 200° C. to 260° C., or equal to any one of, at most any one of, or between any two of 200° C., 205° C., 210° C., 215° C., 220° C., 225° C., 230° C., 235° C., 240° C., 245° C., 250° C., 255° C., and 260° C. The polypropylene and the clarifying and nucleating agents and other additives can be subjected to an elevated temperature for a sufficient period of time during blending. The blending temperature can be above the softening point of the polypropylene.

The clarifying and nucleating agents and other additives can be premixed or added individually to the polypropylene. By way of example, the clarifying and nucleating agents and other additives can be premixed such that they are added to the polypropylene. Incorporation of clarifying and nucleating agents and other additives into the polypropylene can be carried out, for example, by mixing the above-described components using methods customary in process technology. The blending temperature can be above the softening point of the polypropylene. In certain aspects, a process can be performed at a temperature from about 160° C. to 250° C. Such “melt mixing” or “melt compounding” results in uniform dispersion of the present additives in the polypropylene.

### F. Articles Containing the Polymeric Compositions

The polymeric compositions of the present invention can be included in an article of manufacture. In some aspects, the article of manufacture can be an extruded, a blow-molded, rotational-molded, an injection-molded, and/or thermoformed article. In some aspects, the article of manufacture can be transparent. Non-limiting examples of articles of manufacture can include, films, sheets, fibers, yarns, a packing filing, a forming film, a protective packaging, a shrink sleeve, and/or label, a shrink film, a twist wrap, a sealant film, a cap, a crate, a bottle, a jar, a funnel, a pipette tip, a well plate, a microtiter plate, a syringe, a suture, a face mask, personal protective equipment, a medical tool, a medical tray, a sample vial, a cuvette, a reaction vial, contact lens mold, a cigarette filter, a technical filter, woven socks, cold and warm weather sport clothing, undergarments, shoes, ropes, twines, bale warp, tape, construction/industrial fabrics, piping, non-electric fuses for initiating explosives, absorbent products (e.g., diapers), expandable foams, carpets, mats, rugs, furniture, toys, luggage, tote bags, duffle bags, sport bags backpacks, fabrics, food containers and lid, deli containers and lids, dairy containers and lids, vehicle parts, dashboards, bumpers, cladding, exterior trim, film cushioning, film skins, covers, interior vehicle elements. In these and other uses the resins may be combined with other materials, such as particulate materials, including talc, calcium carbonate, wood, and fibers, such as glass or graphite fibers, to form composite materials. Examples of such composite materials include components for furniture, automotive components and building materials, particularly those used as lumber replacement.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1 (Preparation of Polypropylene Composition)

A polypropylene composition (Example 1) was produced by combining a phenolic antioxidant (Irganox 1010, 0.06 wt. %), a secondary antioxidant (Irgafos 168, 0.06 wt. %), a neutralizer (calcium stearate, 0.03 wt. %), a nucleating agent (NA 27, 0.1 wt. %), and a metallocene polypropylene random copolymer base resin (M6571 in fluff form, balance), and extruding the mixture at a melt mass-flow rate (MFR) of 9 dg/min. The phenolic antioxidant, secondary antioxidant, and neutralizer are not believed to contribute to the haze value of the polypropylene composition. The compounds were produced on a 1¼″ single screw extruder with three temperature zones (350° F.-410° F.-420° F. and 420° F. for the die).

### Example 2 (Preparation of Polypropylene Composition)

A polypropylene composition (Example 2) was produced by combining a phenolic antioxidant (Irganox 1010, 0.06 wt. %), a secondary antioxidant (Irgafos 168, 0.06 wt. %), a neutralizer (calcium stearate, 0.03 wt. %), a nucleating agent (HPN 715, 0.1 wt. %), and a metallocene polypropylene random copolymer base resin (M6571 in fluff form, balance), and extruding the mixture at a melt mass-flow rate (MFR) of 9 dg/min. The phenolic antioxidant, secondary antioxidant, and neutralizer are not believed to contribute to the haze value of the polypropylene composition.

### Example 3 (Preparation of Polypropylene Composition)

A polypropylene composition (Example 3) was produced by combining a phenolic antioxidant (Irganox 1010, 0.06 w t. %), a secondary antioxidant (Irgafos 168, 0.06 wt. %), a neutralizer (calcium stearate, 0.03 wt. %), a clarifier (Millad NX8000, 0.2 wt. %), and a metallocene polypropylene random copolymer base resin (M6571 in fluff form, balance), and extruding the mixture at a melt mass-flow rate (MFR) of 9 dg/min. The phenolic antioxidant, secondary antioxidant, and neutralizer are not believed to contribute to the haze value of the polypropylene composition.

### Example 4 (Preparation of Polypropylene Composition)

A polypropylene composition (Example 4) was produced by combining a phenolic antioxidant (Irganox 1010, 0.06 wt. %), a secondary antioxidant (Irgafos 168, 0.06 wt. %), a neutralizer (calcium stearate, 0.03 wt. %), a nucleating agent (NA 27, 0.1 wt. %), a clarifier (Millad NX8000, 0.2 wt. %), and a metallocene polypropylene random copolymer base resin (M6571 in fluff form, balance), and extruding the mixture at a melt mass-flow rate (MFR) of 9 dg/min. The phenolic antioxidant, secondary antioxidant, and neutralizer are not believed to contribute to the haze value of the polypropylene composition.

### Example 5 (Preparation of Polypropylene Composition)

A polypropylene composition (Example 5) was produced by combining a phenolic antioxidant (Irganox 1010, 0.06 wt. %), a secondary antioxidant (Irgafos 168, 0.06 wt. %), a neutralizer (calcium stearate, 0.03 wt. %), a nucleating agent (HPN 715, 0.1 wt. %), a clarifier (Millad NX8000, 0.2 wt. %), and a metallocene polypropylene random copolymer base resin (M6571 in fluff form, balance), and extruding the mixture at a melt mass-flow rate (MFR) of 9 dg/min. The phenolic antioxidant, secondary antioxidant, and neutralizer are not believed to contribute to the haze value of the polypropylene composition.

Table 1 below prepared polypropylene compositions from Examples 1-5.

TABLE 1*

| | Example Number | | | | |
|---|---|---|---|---|---|
| | 1 | 2 | 3 | 4 | 5 |
| | Base Resin Type | | | | |
| | M6571 | M6571 | M6571 | M6571 | M6571 |
| Additive | wt. % | wt. % | wt. % | wt. % | wt. % |
| Irganox 1010 | 0.06 | 0.06 | 0.06 | 0.06 | 0.06 |
| Irgafos 168 | 0.06 | 0.06 | 0.06 | 0.06 | 0.06 |
| Calcium Stearate | 0.03 | 0.03 | 0.03 | 0.03 | 0.03 |
| NA 27 | 0.1 | — | — | 0.1 | — |
| HPN 715 | — | 0.1 | — | — | 0.1 |
| Millad NX8000 | — | — | 0.2 | 0.2 | 0.2 |

*M6571 is a random copolymer metallocene polypropylene (TotalEnergies, Houston, Texas). It has a melt flow index of 9 g/10 min (2.16 Kg-230° C.).
*Irganox 1010 is pentaerythritol tetrakis(3-(3,5-di-tert-butyl-4-hydroxyphenyl)propionate) (BASF, Ludwigshafen, Germany).
*Irgafos 168 is tris(2,4-di-tert-butylphenyl) phosphite (BASF, Ludwigshafen, Germany).
*Calcium stearate is C₃₆H₇₀CaO₄ (Baerlocher, Germany).
NA 27 is 2,2′-methylenebis (4,6,-di-tertbutylphenyl) phosphate with a dispersant (ADK STAB NA-27 Adeka (Tokyo, Japan)).
*HPN 715 is Hyperform HPN 715 (Milliken Chemical, Spartanburg, S.C.).
*Millad NX8000 is 1,2,3-trideoxy-4,5:5,7-bis-O-[(4-propylphenyl)methylene]-Nonitol (Milliken Chemical, Spartanburg, S.C.).

### Example 6 (Results)

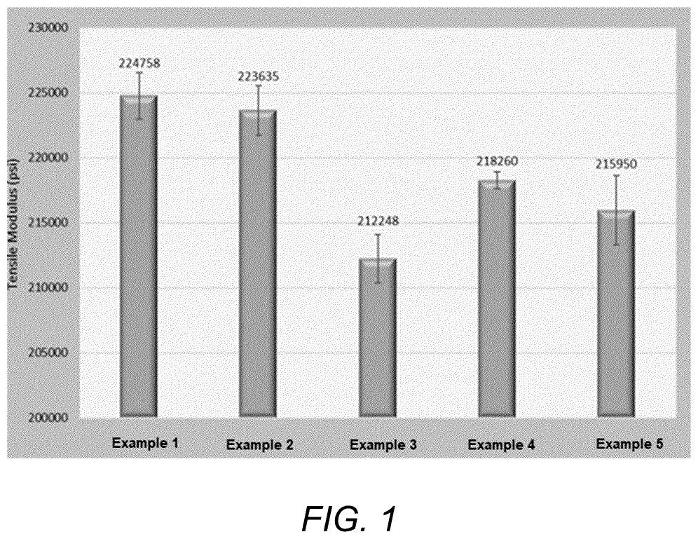

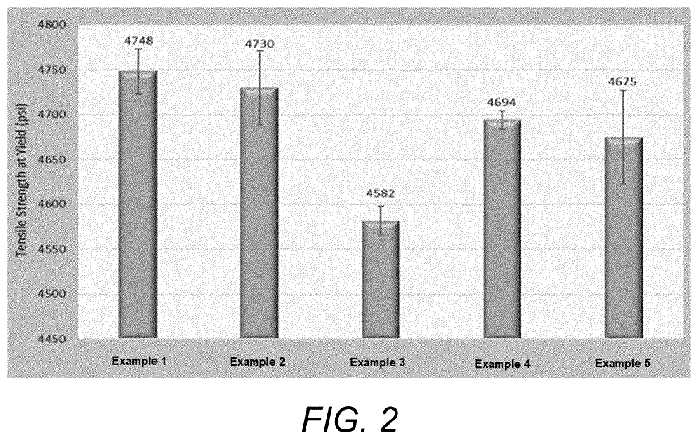

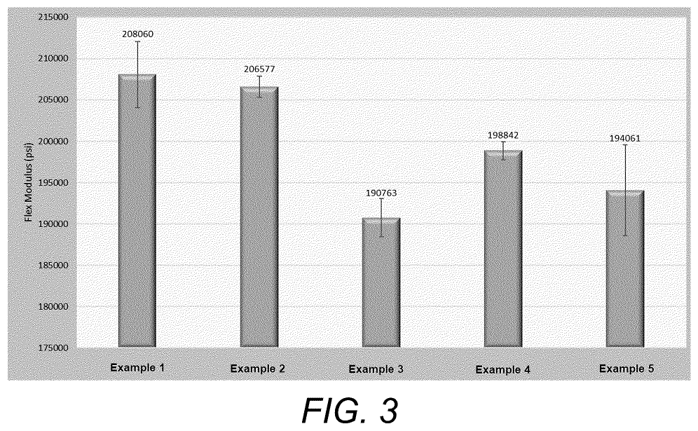

Polypropylene composition Example 1 included a nucleating agent (NA27) and no clarifier. This composition exhibited high tensile modulus (FIG. 1) and high flexural modulus (FIG. 2), but relatively poor clarity (high haze, FIG. 3). Similarly, polypropylene composition Example 2 included a nucleating agent (HPN-715) and no clarifier, and exhibited comparable properties.

Polypropylene composition Example 3 included a clarifier (NX8000) but no nucleating agents and exhibited the desired low haze (FIG. 3). This example, however, exhibited low tensile modulus (FIG. 1) and low flexural modulus (FIG. 2).

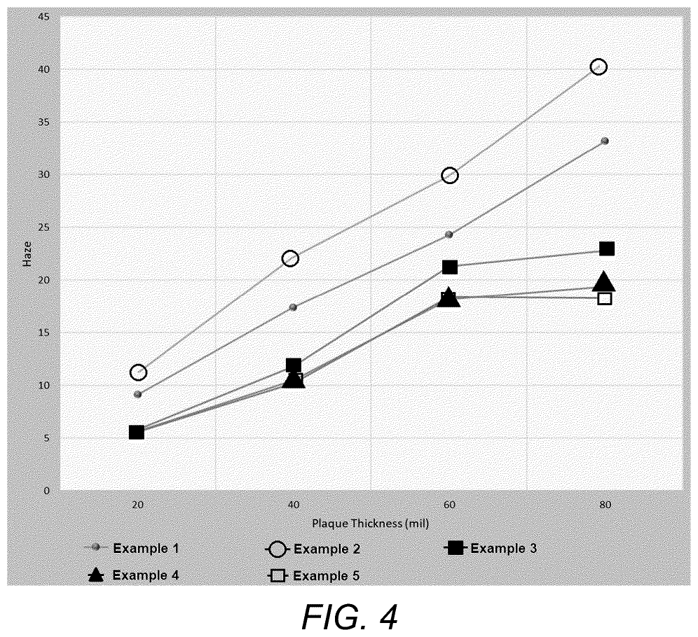

The polypropylene compositions (Examples 4 and 5) that included a nucleating agent (NA 27 or HPN 715, respectively) and a clarifier (NX8000) demonstrated high tensile modulus (FIG. 1), high flexural modulus (FIG. 2), and high clarity (low haze, FIG. 3). The decreased haze was more evident in thicker molded plaques, where the magnitude of haze difference over the single-additive compositions discussed above was greater (FIG. 4, see 80 mil plaque thickness). By including both a nucleating agent and a clarifier in polypropylene compositions, high stiffness polypropylene compositions that retain high clarity in thicker product applications has been obtained. These results can be attributed to a synergistic effect achieved by the combination of a nucleating agent and a clarifier in polypropylene compositions.

Table 2 below depicts Notched Izod Impact test results for the various polypropylene compositions described above.

TABLE 2

| Example Number | | 1 | 2 | 3 | 4 | 5 |
|---|---|---|---|---|---|---|
| Izod-Impact - Notched | ft-lb/in | 0.8 | 0.8 | 0.8 | 0.8 | 0.8 |
| St. Dev | ft-lb/in | 0 | 0.1 | 0 | 0.1 | 0 |
| Break Type - Notched | | Complete | Complete | Complete | Complete | Complete |
| | | break | break | break | break | break |

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A polymeric composition comprising:
(a) at least 95 wt. % of a polypropylene;
(b) a clarifying agent; and
(c) a nucleating agent,
wherein the presence of the clarifying agent and nucleating agent in the polymeric composition decreases the haze value, as determined by ASTM D1003 at a thickness of 40-80 mil, of the polymeric composition when compared with the haze value of the polymeric composition having the clarifying agent but not the nucleating agent.

2. The polymeric composition of claim 1, wherein the composition comprises 0.01 to 0.5 wt. % of the clarifying agent, and 0.01 to 0.5 wt. % of the nucleating agent.

3. The polymeric composition of claim 2, wherein the composition comprises 0.1 to 0.3 wt. % of the clarifying agent, and 0.05 to 0.2 wt. % of the nucleating agent, or wherein the composition comprises the clarifying agent and the nucleating agent at a wt. % ratio of 0.01/5 to 0.5/0.01.

4. The polymeric composition of claim 3, wherein the clarifying agent is a nonitol-based clarifying agent or a trisamide-based clarifying agent and the nucleating agent is a phosphate ester based nucleating agent.

5. The polymeric composition of claim 4, wherein the nonitol-based clarifying agent is 1,2,3-trideoxy-4,5:5,7-bis-O-[(4-propylphenyl)methylene]-nonitol, or the trisamide-based clarifying agent is a 1,3,5-benzenetrisamide amide derivative, preferably 1,3,5-tris(2,2-dimethyl propanamido)benzene.

6. The polymeric composition of claim 4, wherein the phosphate ester-based nucleating agent is 2,2′-methylenebis (4,6,-di-tertbutylphenyl) phosphate.

7. The polymeric composition of claim 4, wherein the clarifying agent is 1,2,3-trideoxy-4,5:5,7-bis-O-[(4-propylphenyl)methylene]-nonitol, and the nucleating agent is 2,2′-methylenebis (4,6,-di-tertbutylphenyl) phosphate.

8. The polymeric composition of claim 1, wherein the presence of the clarifying agent and nucleating agent in the polymeric composition increases the tensile modulus, as determined by ASTM D638, of the polymeric composition when compared with the tensile modulus of the polymeric composition having the clarifying agent but not the nucleating agent.

9. The polymeric composition of claim 1, wherein the haze value is decreased by at least 1%, preferably by at least 2%, more preferably by 1% to 5%, or even more preferably by 2% to 5%.

10. The polymeric composition of claim 1, wherein the haze value of the polymeric composition comprising the clarifying agent and the nucleating agent is less than or equal to 20% or 15% to 20%, and wherein the haze value of the polymeric composition comprising the clarifying agent but not the nucleating agent is greater than 20% or greater than 20% to 25%.

11. The polymeric composition of claim 1, wherein the polypropylene is a homopolymer or a random copolymer or a blend thereof.

12. The polymeric composition of claim 1, wherein the polypropylene is a Zieglar-Natta catalyzed polypropylene or a metallocene-catalyzed polypropylene.

13. The polymeric composition of claim 1, wherein the polymeric composition has a melt flow index of 0.2 to 150 g/10 min as measured by ASTM D1238 (230° C./2.16 kg).

14. The polymeric composition of claim 1, wherein the polymeric composition further comprises an additive.

15. The polymeric composition of claim 14, wherein the additive is an antioxidant, an acid neutralizer, an antistatic agent, an antiblock agent, an antifog agent, an anticorrosion agent, a ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer, a fire retardant, a mold release agent, a dye, a blowing agent, a fluorescent agent, a surfactant, or any combination thereof.

16. The polymeric composition of claim 1, wherein the polymeric composition has at least one of the following properties:
a tensile modulus of 200,000 to 230,000 psi, as measured by ASTM D638;
a tensile strength at yield of 4,400 to 4,800 psi, as measured by ASTM D638;
a flex modulus of 180,000 psi to 220,000 psi, as measured by ASTM D790; and/or
a notched izod impact strength of 0.5 to 1.5 ft-lbs/in, as measured by ASTM D256.

17. The polymeric composition of claim 1, wherein the polymeric composition has a thickness of at least 2 mil, preferably at least 5 mil, more preferably at least 10 mil, or even more preferably 20 mil to 300 mil, or even still more preferably 20 mil to 100 mil.

18. The polymeric composition of claim 1, wherein the polymeric composition is an injection molded polymeric composition.

19. An article of manufacture comprising the polymeric composition of claim 1.

20. A method of making the article of manufacture of claim 19, the method comprising obtaining the polymeric composition of claim 1 and making the article of manufacture by injection molding, blow molding, compression molding, stretch molding, rotational molding, transfer molding, sheet extrusion thermoforming, shallow-draw thermoforming, deep-draw thermoforming, or profile extrusion.

21. The method of manufacture of claim 20, wherein the article of manufacture is an injection molded article of manufacture, preferably having a thickness of 20 mil to 100 mil.

22. A method of producing the polypropylene composition of claim 1, the method comprising:
(a) obtaining a composition comprising:
at least 95 wt. % of the polypropylene;
a clarifying agent; and
a nucleating agent; and
(b) extruding the composition to obtain the polypropylene composition of claim 1.

23. The method of claim 22, wherein the extrusion conditions include melt temperatures of 200-260° C.
